(19) United States
(12) Patent Application Publication
(10) Pub. No.: US 2007/0038471 A1
(43) Pub. Date: Feb. 15, 2007

(54) Method and system for medical communications

(75) Inventors: James L. Meisel, Newton, MA (US); Philip Libin, Cambridge, MA (US); Vladimir I. Valtchinov, Newton, MA (US)

Correspondence Address: EDWARDS & ANGELL, LLP, P.O. BOX 55874, BOSTON, MA, 02205, US

(73) Assignee: Medvance Solutions Inc, Newton, MA (US)

(21) Appl. No.: 10/531,968

(22) PCT Filed: Oct. 21, 2003
(86) PCT No.: PCT/US03/33495

§ 371 Date: Jul. 26, 2006

Related U.S. Application Data
(60) Provisional application No. 60/420,325, filed on Oct. 21, 2002.

(51) Int. Cl. G06Q 10/00

(52) U.S. Cl. 705/2; 706/909

(57) ABSTRACT

Providing medical communications to patients using the steps of receiving first data relating to a test from a laboratory via electronic data interchange and retrieving second data relating to a patient associated with the first test data. A medplate is selected medplate based upon the first test data and autopopulated medplate based upon the first test data and the second patient data. Transformation rules are applied to select default textual fragments based upon the first test data. The medplate also has alternative textual fragments when presented for review. The physician modifies the default and alternative textual fragments to finalize the medplate and a correspondence based upon the modified medplate is automatically generated and sent to the patient.

### CROSS-REFERENCE TO RELATED APPLICATION

This application claims priority to U.S. Provisional Patent Application No. 60/420,325, filed Oct. 21, 2002, which is incorporated herein by reference in its entirety.

### FIELD OF INVENTION

The present invention relates to a method and system for providing clinician-patient communication.

### BACKGROUND OF THE INVENTION

Over the years, patients have become more educated by having access to the wealth of medical and health information available from various sources such as the Internet. Patients have become more demanding of more and improved information from their physicians. The deregulation of medical advertising made patients more aware of various prescription medications not necessarily suitable for most patients with a particular medical condition. Thus, when visiting a physicians' office, patients have more questions, ask for more detailed explanation and for more information. This need for information is also present when patients receive test results. At the same time, the current healthcare environment creates more pressure to control costs, which usually results in physicians needing to see increased numbers of patients each day. Thus there is an increased demand on physicians to provide high quality medical services in a time efficient manner.

Presently, a patient goes to a clinician (a physician or health care professional in general) for a routine checkup or when not feeling well. The physician evaluates the patient's symptoms and may order appropriate laboratory tests. The patient goes home and awaits test results and further communication from the physician. After the clinician receives the laboratory results, she should communicate these results to the patient because such failure may possibly result in medical complications and even malpractice. Currently, however, there exists no consistent, convenient process for communicating normal or mildly abnormal clinical lab results to patients. Depending on the test results, the communication, if it occurs, is usually done by a telephone call, by mail, or in person during a second appointment at the physician's office. To make the decision about the proper follow up, the physician has to first review the test results and then initiate an appropriate course of action.

Typically, the daily volume of test results (the vast majority of which are normal or mildly abnormal) ordered is such that physicians and their staffs spend hours each day reviewing and responding thereto. Sometimes, the test results do not arrive at the physician's office or are misplaced at the office without being reviewed. For these reasons, often the appropriate follow up occurs very late, if at all. Alternatively, even if a communication is generated, the process involves a great deal of time and energy with a result that is usually duplicative of previous correspondence with different patients. Additionally, the opportunity for an error to occur is prevalent. Under such circumstances, an error may rise to the level of malpractice. Thus, a system that allows building upon previous efforts and keeping track of test results would be beneficial for ensuring that patients are properly cared for and in preventing malpractice claims.

From their perspectives, patients may receive a communication that cannot be adequately understood because the doctors' handwriting is illegible, the content is written in medical jargon or the communication is not in the patients' native language. The patient may alternatively receive a typewritten note that is expensive to produce, or be obligated to play “phone tag” with the clinician or his staff. For an example of phone tag, a physician may not be able to reach a patient and leaves a voice message on the patient's answering machine. When returning the physician's call, the patient may not be able to reach the physician and may just leave a message for the physician. A patient may call several times to inquire about his or her test results, but the physician may not be available to take the call. Patients, physicians and their staff may find this type of communication time consuming as well as exasperating and may give up out of frustration. For all these reasons, most often patients receive no information at all from their clinicians about this critical reporting link in the process of their health care.

Many patients require correspondence in their native languages. Thus, upon receipt of a typical English-language communication from his doctor, the patient would be forced to seek the services of a translator. This is a cumbersome and expensive endeavor for the patient that usually does not take place. Similarly, patients with low functional literacy abilities may be unable to understand their doctors' messages. Thus, a system that allows automatic language or literacy translation would be beneficial for ensuring that patients are properly cared for and aid in preventing malpractice claims.

When communicating with the patient, a clinician may write or dictate a letter that may include handwritten notes or comments on the lab printouts marking the various results of the tests. Such marked-up copies may be placed into the patient's chart for subsequent review and comparison with previous or later tests. Often the physician's notes are insufficient for subsequent practitioners if legible at all. This common procedure also does not result in an easily retrievable database of medical results and the corresponding physician's recommendations. Thus, a clear record is not available if there is a claim of medical malpractice.

During the office visit, a physician may prescribe medication or subsequent tests for the patient, or initiate scheduling for a subsequent appointment or test. The pressure to complete tasks quickly often leads physicians to poorly explain medical conditions, risk factors, variations in treatment and the like. As a result, the patient may feel frustrated because of a lack of understanding of their medical condition, or a lack of understanding of the test results. In fact, because it has been shown that good patient communication and complete education of a patient about his or her illness results in patients being better able to adhere to care plans and in seeing improvement in their medical conditions, it is likely that good patient communication and complete education of a patient about his or her test results, per se, would yield similar benefits. Furthermore, usually patients are more satisfied with medical service if they feel that they are informed about their health condition, treatment options and prognosis. A method and system that would provide ample individualized information to the patients would greatly reduce their frustration, which has been well-documented. A system that documents the completion of the necessary correspondence while facilitating such correspondence would greatly improve patient-clinician communication.

In short, whether it is by a letter, a telephone call or during a subsequent visit, present methods of post-visit patient communication are time consuming, inefficient and costly. Thus, a need exists for a system which facilitates physician to patient communication in an efficient manner.

In view of the above, several systems have been developed in an effort to enhance provision of services generally and of medical services in particular. For example, many word processing programs provide templates for common correspondence such as letter and memos. Such programs prompt the user for information which is arranged into a standardized format of the desired type. To mention a few shortcomings, the word processing programs do not provide any information, collate related information, provide sample text for the user to select, or reduce most of the efficiencies inherent in the processes described above. As a result, the efficiency increase is merely related to reduced formatting within the document.

For another example, U.S. Pat. No. 6,234,964 to Illiff discloses a disease management system and is incorporated herein by reference in its entirety. The system of Illiff is intended to replace the physician by controlling the continuing medical care of the patient Health state measurements are entered into the system for review and evaluation. Based upon the review, recommendations for adjusting the patient's therapy are created. The system of Illiff is typical in that it seeks to replace the clinician with a computer in an effort to standardize and automate the services provided. The system of Illiff does nothing to aid the clinician in providing service. In short, the disclosure of Illiff is typical in that it seeks to replace rather than help the physician.

In view of the above, there is a need for a method and a system that improves medical communication between the patient and clinician in an efficient manner.

### DEFINITIONS

The instant invention is most clearly understood with reference to the following definition:

A computer readable medium shall be understood to mean any article of manufacture that contains data that can be read by a computer or a carrier wave signal carrying data that can be read by a computer. Such computer readable media includes but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on carrier wave signal received through a network, wireless network or modem, including radio-frequency signals and infrared signals.

### SUMMARY OF THE INVENTION

It is an object of the subject disclosure to provide a system that creates an easily retrievable database of medical results and the corresponding physician's recommendations for ensuring that patients are properly cared for and in preventing malpractice claims.

It is an object of the subject disclosure to aid physicians in efficiently generating patient correspondence in an error free manner. It is an object of the subject disclosure to provide ample information to the patient for reducing the frustration of patients. It is an object of the subject disclosure to provide a system that collates related information and provide sample text for the physician to select when generating correspondence.

In one aspect, the invention increases productivity of physicians and their medical staff. In another aspect, the invention reduces strain on physicians and their medical staff. In another aspect, the invention decreases medical liability for physicians. In another aspect, the invention helps educate physicians about “best practices” as they accomplish their usual related workflow. In another aspect, the invention increases patient satisfaction, education and involvement.

In one embodiment, the present invention is directed to a method for providing medical communications to patients including the steps of receiving first data relating to a test from a laboratory via electronic data interchange and retrieving second data relating to a patient associated with the first test data. A medplate is selected based upon the first test data and autopopulated based upon the first test data and the second patient data. A rule is applied to select default textual fragments based upon the first test data and provide alternative textual fragments within the medplate. The medplate is presented for review and receipt of selection input regarding use of the default and alternative textual fragments to modify the medplate. Upon approval, a correspondence to the patient is automatically generated based upon the modified medplate and send to the patient.

Another embodiment of the present invention is directed to a system for generating patient communication from a physician to a patient using a display device and an interface for facilitating interaction between the physician and a processor, including a computer for generating a medplate including snippets of medical text selected from a repository. The computer also provides for interactive intuitive selecting of portions of the medical text for inclusion in the patient communication, wherein the computer is interfaced with a database for providing medical information as an attachment to the patient communication.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

FIG. 1 is a diagram showing an environment having a medical communication system in accordance with the subject disclosure;

FIG. 2 is a block diagram of a medical communication system implemented in accordance with the subject disclosure;

FIG. 3 is a flow diagram of a process performed by the medical communication system of FIG. 2;

FIG. 4 is exemplary medplate as seen by a clinician during generating a correspondence in accordance with the subject disclosure; and

FIG. 5 is an exemplary correspondence generated from the medplate of FIG. 4.

### DESCRIPTION OF THE PREFERRED EMBODIMENTS

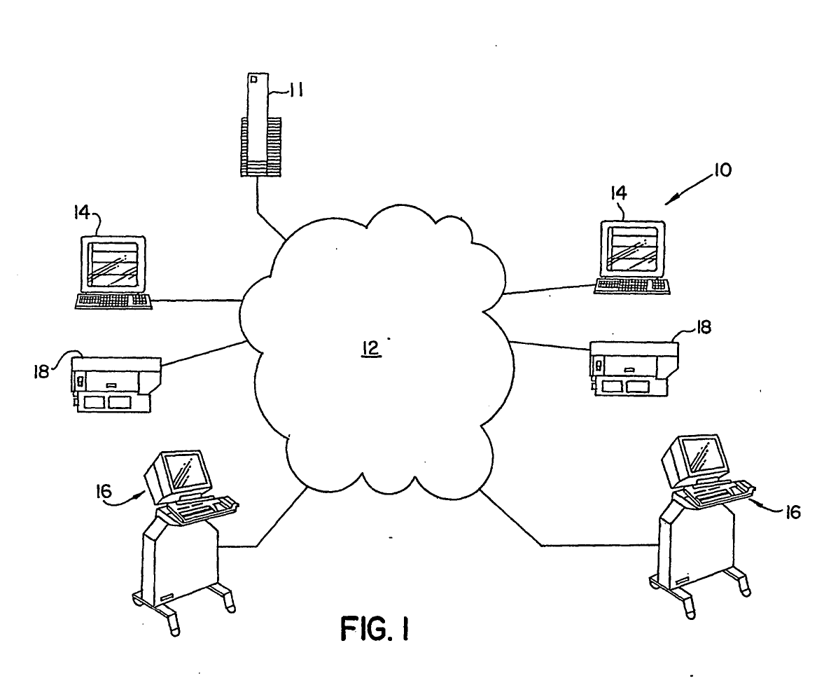

Referring now to the various figures of the drawing, wherein like reference numerals refer to like parts, there is shown in FIG. 1 a block diagram of an environment 10 with medical computer system embodying and implementing the methodology of the present invention. The following discussion describes the structure of such an environment 10 but the discussion of the applications program and data modules that embody the methodology of the present invention is described elsewhere herein.

The environment 10 includes one or more servers 11 which communicate with a distributed computer network 12 via communication channels, whether wired or wireless, as is well known to those of ordinary skill in the pertinent art. For simplicity, one server 11 is shown. Server 11 hosts multiple Web sites and houses multiple databases necessary for the proper operation of the system of the subject invention.

The server 11 is any of a number of servers known to those skilled in the art that are intended to be operably connected to a network so as to operably link to a plurality of clients 14, 16 via the distributed computer network 12. As illustration, the server 11 typically includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the server may be used for storing data, client applications and the like utilized by client applications. The hard disk drive(s) of the server 11 also are typically provided for purposes of booting and storing the operating system, other applications or systems that are to be executed on the server, paging and swapping between the hard disk and the RAM.

It is envisioned that the server 11 can utilize multiple servers in cooperation to facilitate greater performance and stability of the subject invention by distributing memory and processing as is well known. U.S. Pat. No. 5,953,012 to Venghte et al. describes a method and system for connecting to, browsing and accessing computer network resources and is herein incorporated by reference in its entirety. Similarly, U.S. Pat. No. 5,708,780 to Levergood et al. describes an Internet server which controls and monitors access to network servers and is also herein incorporated by reference in its entirety.

Distributed computer network 12 may include any number of network systems well known to those skilled in the art. For example, distributed computer network 12 may be a combination of local area networks (LAN), wide area networks (WAN), intranets or the Internet, as is well known. In the preferred embodiment, the computer network 12 is the Internet. The preferred method of accessing information on the Internet is the World Wide Web, because navigation is intuitive and does not require technical knowledge.

The environment 10 also includes a plurality of computers or clients 14, 16 having displays and an input device(s) as would be appreciated by those of ordinary skill in the pertinent art. For simplicity, only four clients 14, 16 are shown. The display may be any of a number of devices known to those skilled in the art for displaying images responsive to outputs signals from the computers 14, 16. Such devices include but are not limited to cathode ray tubes (CRT), liquid crystal displays (LCDS), plasma screens and the like. Although a simplified diagram is illustrated in FIG. 1 such illustration shall not be construed as limiting the present invention to the illustrated embodiment. It should be recognized that the signals being outputted from the computer can originate from any of a number of devices including PCI or AGP video boards or cards mounted within the housing of the computers 14, 16 that are operably coupled to the microprocessors and the displays of the computers 14, 16.

Computers 14 are typically to provide patient access to the environment 10 whereas computers 16 provide physicians, laboratory technician, medical staff and the like access. A plurality of users may share the same computer 14, 16. The plurality of users can utilize the environment 10 simultaneously. The clients 14, 16 allow users to access information on the server 11.

The computers 14, 16 are prefereably equipped with input device(s) as is known to those skilled in the art which can be used to provide input signals to the computers 14, 16 for control of applications programs and other programs such as the operating system being executed within the computers 14, 16. In illustrative embodiments, the input device preferably comprises a switch, a slide, a mouse, a track ball, a glide point or a joystick, a microphone or other such device (e.g., a keyboard having an integrally mounted glide point or mouse) by which a user such as a physician can input control signals other than by means of a keyboard. Although the use of a keyboard as an input device is not described further herein, it is within the scope of the present invention for the input device to comprise any of a number of keyboards known to those skilled in the art, wherein the control signals or commands for implementing the language learning methodology and the applications program embodying such methodology are implemented in the form of discrete commands via the keyboard.

The clients 14, 16 typically include a central processing unit including one or more micro-processors such as those manufactured by Intel or AMD, random access memory (RAM), mechanisms and structures for performing I/O operations (not shown), a storage medium such as a magnetic hard disk drive(s), a device for reading from and/or writing to removable computer readable media and an operating system for execution on the central processing unit. The clients 14, 16 may also be hand-held devices including PDAs (personal digital assistants), internet-enabled mobile phones and the like.

According to one embodiment, the hard disk drive of the clients 14, 16 is for purposes of booting and storing the operating system, other applications or systems that are to be executed on the computer, paging and swapping between the hard disk and the RAM and the like. In one embodiment, the application programs reside on the hard disk drive for performing the functions of the invention. In another embodiment, the hard disk drive simply has a browser for accessing an application hosted within the distributed computing network 12 such as the Internet. The clients 14, 16 can also utilize a removable computer readable medium such as a CD or DVD type of media that is inserted therein for reading and/or writing to the removable computer readable media. The environment 10 also includes a plurality of printers 18 for generating correspondence.

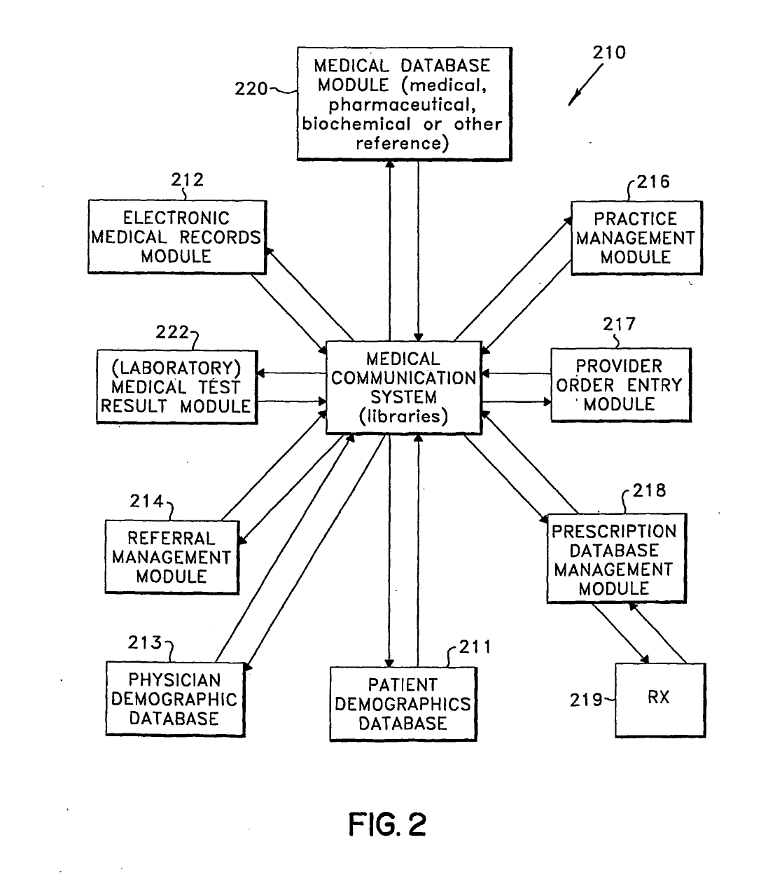

FIG. 2 is a block diagram showing a medical communication system 210 interfaced with several optional modules and databases for retrieving and communicating medical information. In a preferred embodiment, the medical communication system 210 operates as an application on the server 110 of the environment 100 of FIG. 1. The medical communication system 210 can retrieve data from and provide data to an electronic medical records module 212 and can retrieve data from a referral management module 214. The medical communication system 210 can also communicate with a practice management module 216 and retrieve medical test data from a medical test database 222. The medical communication system 210 also includes a provider order entry module 217 by which a user could order clinical tests electronically. Furthermore, medical communication system 210 can interact with a prescription database management module 218 when generating a prescription for example as an attachment to a patient correspondence. Preferably, the prescription database management module 218 is directly linked to pharmacies 219 in order to provide the pharmacies 219 with information from the medical communication system 210. The medical communication system 210 also communicates with a medical database module 220, a patient demographics database 211 and a physician demographic database 213. Each of the several databases stores medical text and/or medical data used to generate medical communication and send the communication to a patient.

The electronic medical records module 212 is preferably an external software module that provides integrated information management for review by a clinician. The electronic medical records module 212 include one or several databases and applications that allow health care providers to document and input notes related to patients, access laboratory and other test results, enter orders and receive educational feedback.

The referral management module 214 permits or helps referral of patient and patient-related information to other entities in the health care system. Preferably, the communication with the other entities is by the distributed computer network 120 although traditional mail and other methods may be utilized. The referral management module 214 receives information back from those entities that interact with other practice management, the electronic medical records module 212, billing, coding, and other applications and the corresponding databases.

The practice management module 216 supports the infrastructures of outpatient clinical care. The practice management module 216 may include registration, billing and coding, demographic, scheduling, referral applications and the corresponding databases

The prescription database management module 218 includes a database of drugs, doses, indications, contra-indications, interactions, side effects, and also may include integrated software to provide written, faxed or e-mailed prescriptions. The medical communication system 210 includes provides written, faxed or e-mailed prescriptions directly to pharmacies 219, which are initiated by a clinician when interacting with a medplate described below.

The patient demographic database 211 includes demographic data about patients (such as name, postal address, email address, fax number, etc.), which is retrieved as necessary. The physician demographic database 213 includes demographic data about doctors (such as name, postal address, email address, fax number, etc.), which again is retrieved by the system as necessary. The medical database module 220 includes reference information for physicians to access when diagnosing patients and reference materials for patients upon diagnosis.

The medical test result database 222 includes medical test result data for patients such as the quantitative (i.e., numeric) or qualitative (i.e., textual) results of medical laboratory tests, which are retrieved as necessary. Optionally, the medical communication system 210 also includes a separate database that can provide the patient with in depth information. As a result, the delivered communication may include a link to such database such as a Web address or a phone number to an automated system for providing the information (if desired by the patient). This will help reduce the anxiety a patient may feel until receiving further results and increase understanding which, in turn, leads to increased patient compliance with proper regimens.

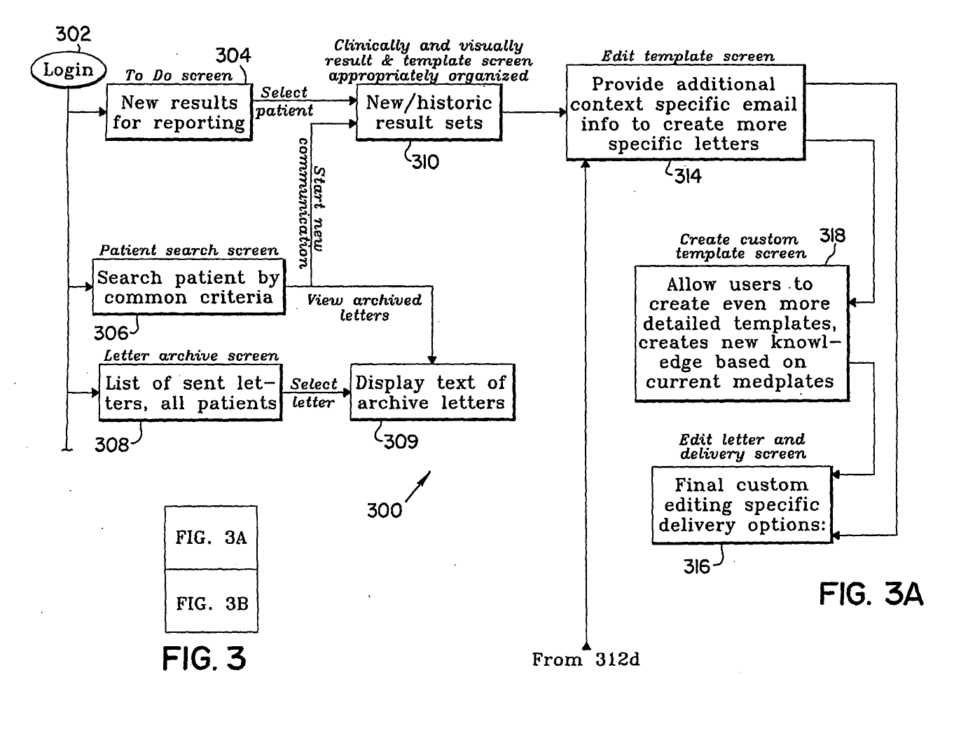

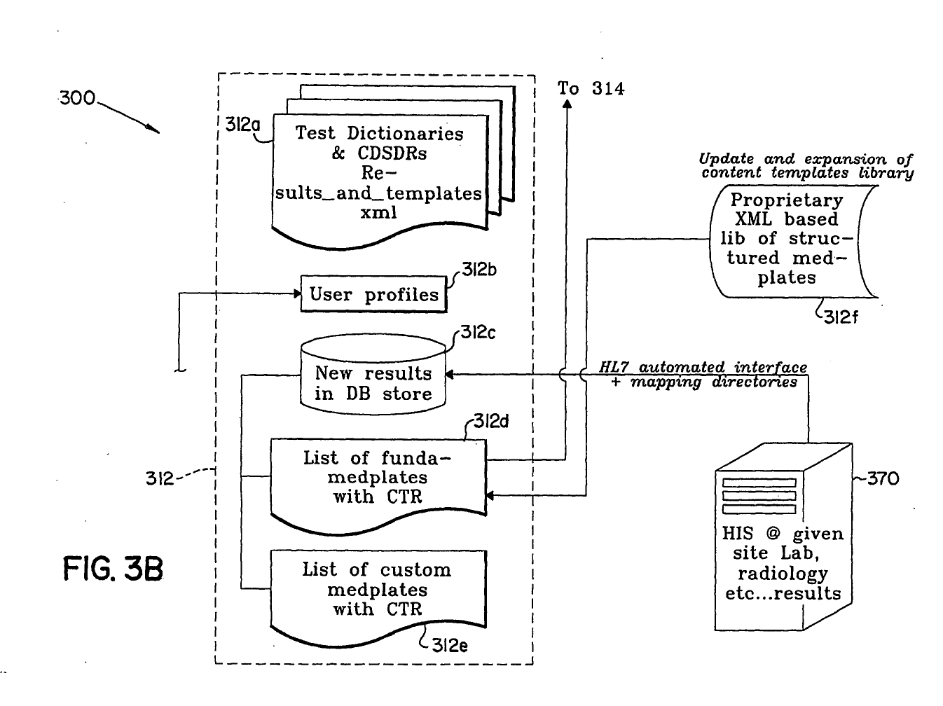

Referring now to FIG. 3, there is illustrated a flowchart 300 depicting a process for facilitating communication between health care providers and patients in accordance with an embodiment of the present invention. In the preferred embodiment, a company (not shown) hosts a Web site to provide access for health care practitioners to utilize the medical communication system 210. Further, the company may maintain banner advertisements and links to related Web sites as a source of additional revenue. Preferably, the banner advertisements and links are associated with national and local vendors of medical related goods and services and the company receives a further fee based upon referrals.

It is envisioned that the hosted medical communication system 210 provides for administration and security maintenance. Therefore, although each user (e.g., patients and doctors) of the subject invention has access to a user interface, each group's access is controlled. The interface specifies which aspects of the program can be accessed, and at what level in order to maintain compliance with technical electronic data interchange standards and legal confidentiality restraints such as HIPAA. Such limitations of functionality are well known to those skilled in the art and therefore not further described herein. When a health care provider contracts for access to the medical communication system 210, she or a member of the staff is typically provided with administrative access to perform such tasks as removing and adding patients to the patient database 211, customizing medplates, administering access by other users, generating reports and the like.

At step 302, a physician accesses the medical communication system 210 via a client 102. Once logged in to the medical communication system 210 the physician has several options. Preferably, the physician is presented with any recent relevant tests results in order to prompt generation of reporting the results. In a preferred embodiment, the test results are automatically input to the medical test result module 222 of the medical communication system 210 via a client 104 located at the laboratory. If the physician wishes to review and report the test results, she proceeds to step 304 preferably by selecting an icon related to the new test results.

At step 304, it is envisioned that a plurality of new test results may be displayed. As such, the physician selects a particular patient's results for further processing. At step 310, the physician is presented with the test results for the selected patient. Preferably, the test results include the most recent results and the relevant history for the patient. After review of the results, if the physician desires to generate a communication to the patient, she selects an intuitive icon that presents a medplate based upon the reviewed test results.

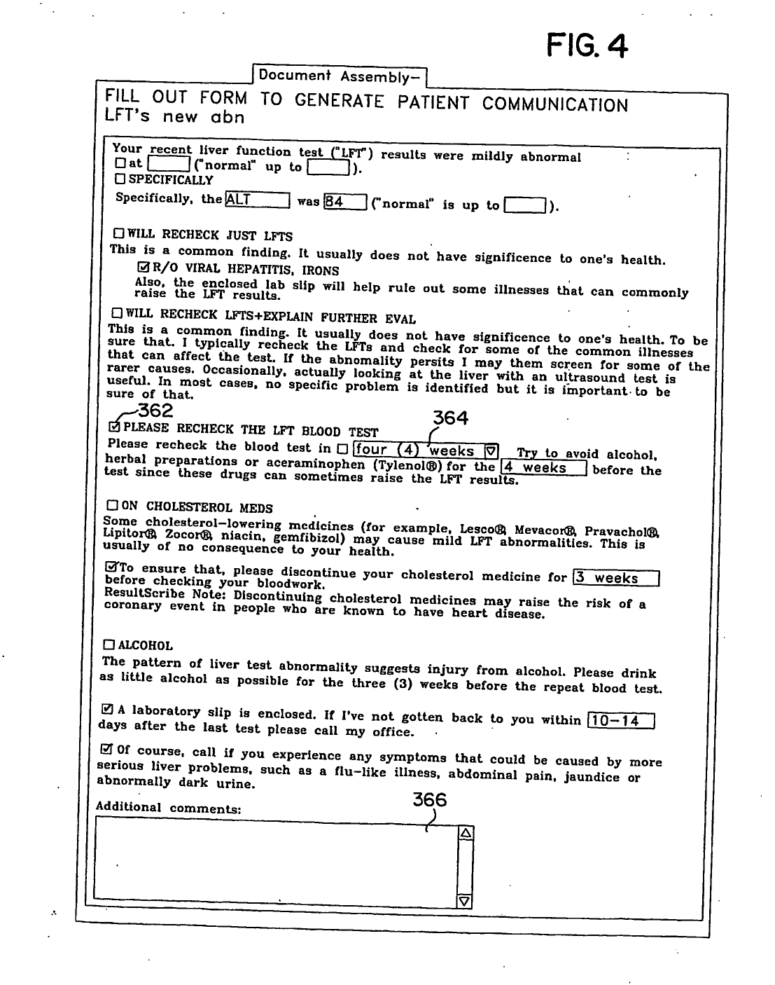

Referring now to FIG. 4, an exemplary medplate for a liver function test (“LFT”) is shown and referred to generally by reference numeral 360. The medplate 360 has a plurality of snippets, wherein each snippet pertains to a particular piece of information that may be relevant to the LFT. The physician can enable use of each snippet by selection of a corresponding checkbox as is well known to those of ordinary skill in the pertinent art. Additionally, each snippet may include a blank box in which statistics or words can be entered by the physician or autopopulated based upon the test results. Preferably, all available information relating to the test and patient is accessed and autopopulated within the medplate 360 and resulting correspondence. Autopopulation occurs when any or all of the fields of the medplate 360 automatically receive information from other internal or external databases such as the patient demographic database 211, the physician demographic database 213, or the medical test result database 222.

Referring now to FIGS. 3 and 4, at step 310 the physician checks the medplate 360 and makes appropriate recommendation to insure that appropriate recommendations are being made to the patient and selects or confirms possible attachments (if any). In addition to educating the patient and the physician, the communication may include a prescription for more tests, a follow-up with a registered nurse or therapist, request to schedule a visit with the same or another physician, a prescription for a medication, a change of existing medication and the like. The communication may also include a referral to a specialist or recommendation for lifestyle modification.

At step 314, if the physician wants to revise the information, the selection of checkboxes and entries within the blank boxes facilitate customizing the medplate 360 and, in turn, the resulting correspondence. For example, checkbox 362 is selected and blank box 364 filled in so that the patient will be informed to recheck the LFT in four (4) weeks. Additionally, a free form comments area 366 is provided so that the physician can input text for inclusion in the correspondence. Another check box may provide certain informational attachments with the patient correspondence when selected. The medical communication system 210 may also use pull-down menus and other intuitive programming techniques now known and later developed to facilitate completion of the medplate 360 by the physician.

The snippets for the medplate 360 come from the various databases and/or libraries within the medical communication system 210. In FIG. 2, several such databases 212, 222, 211, 218, 220 are depicted but it will be appreciated that the subject invention may have more or less such databases. In FIG. 3, the databases and other sources of information are represented in area 312 as a test dictionary 312a, user profiles 312b, new results 312c, lists of fundamental medplates 312d (e.g., from the libraries of the medical communication system 210), custom medplates 312e and a library of structured medplates 312f.

In a preferred embodiment, the test dictionary 312a is the latest accepted standard method of codifying and defining medical conditions, tests, results, and synonyms and associations for the same. For example, SNOMED Clinical Terms (“SNOMED CT”) is a work of terminology of the College of American Pathologists. SNOMED CT is an extensive clinical terminology of over 344,000 concepts that covers most aspects of clinical medicine. SNOMED CT is meant to be complementary to Logical Observations Identifiers, Names, Codes (“LOINC”), which is another clinical terminology for laboratory test orders and results. SNOMED CT is concept-oriented and has an advanced structure that meets most accepted criteria for a well-formed, machine-readable terminology. It is envisioned that other dictionaries could be used. For example, several services develop and distribute multi-purpose, electronic knowledge sources and associated lexical programs. One skilled in the pertinent art based upon review of the subject disclosure can use knowledge source products to enhance their applications focused on patient data, digital libraries, Web and bibliographic retrieval, natural language processing, and decision support.

It is envisioned that in a hospital environment a server 370 could store the majority of information required for the medical communication system 210. Server 370 represents the hospital information system (“HIS”) and would be connected to the distributed computer network 120, as necessary, to send and receive information such as test results and the like. In another embodiment, the individual medical snippets are arranged according to class. For example, the snippets may be stored from a result-specific library, a disease-specific library, or a symptoms-based library. It will be appreciated that the server 370 could be any of a variety of hosting arrangements for the medical communication system 210 such as a LAN, WAN and the like.

The default selections of the medplate 360 are based on transformation rules. The defaults are mostly determined based on the most common selections and based on the goal of increasing the medical communication system's speed and efficiency. For example, a transformation rule may be exclusionary in that the transformation rule will not allow selection of both the check boxes for normal and abnormal results. Further, a transformation rule may be inclusionary in that the transformation rule will automatically request the patient to contact the physician's office to reschedule a test if the test results were abnormal. Preferably, the input captured from the physician at step 314 combined with the default medplate information, constitutes all the information required for the completed communication to be generated and the process typically proceeds to step 316. In a preferred embodiment, the transformation rules (also referred to as CTR (clinical transformation rules) and CDSDR (clinical decision support display rules)) can be modified as desired by the physician.

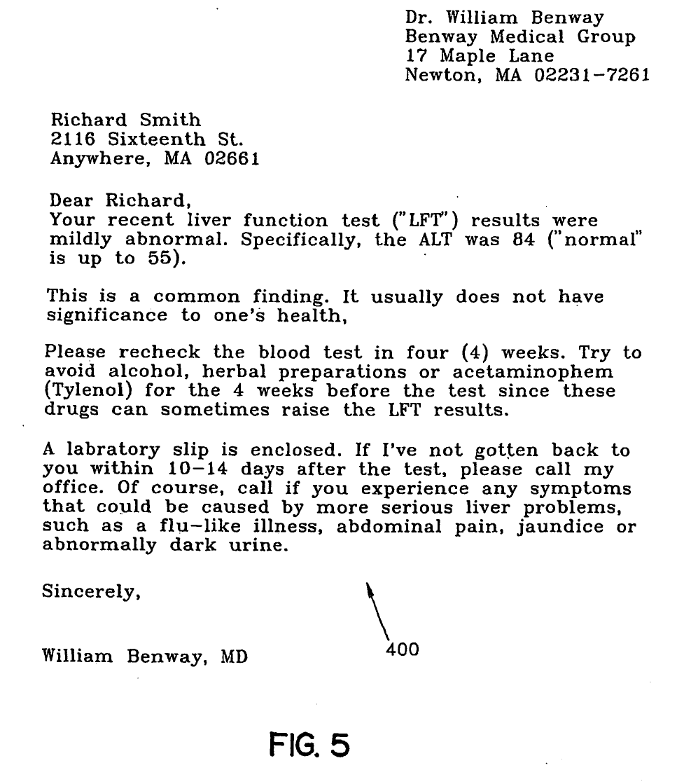

At step 316, the medical communication system 210 generates a correspondence to the patient based upon the modified medplate 360. Referring now to FIG. 5, an exemplary correspondence generated from the medplate 360 is referred to generally by the reference numeral 400. The correspondence 400 is presented to the physician for final review and modification. After the clinician has determined that the communication is ready for delivery to the patient, it is delivered via one or more delivery channels such as postal delivery, e-mail delivery, fax delivery, Web page delivery and other methods now known and later developed. Typically, the physician may use a printer 18 to generate a hard copy for signature and mailing. For some types of delivery, the patient may need to perform some action to retrieve the communication or be able to initiate a return confirmation. One typical modification at step 316 is translating the correspondence 400 and any attachments into the patient's native language.

In the preferred embodiment, delivery of the correspondence is by email by transforming the letter's contents, for example using an XSLT transformer into plain text suitable for delivery via SMTP (simple mail transfer protocol), and then handing the plain text off to an SMTP agent. The communication delivery via a web page may be realized by transforming the communication contents using a different XSLT transformer into HTML suitable for presentation on a Web page, and then handing the HTML off to a Web application for that purpose. Since patient confidentiality is so important, the email correspondence is preferably via a secure channel and encrypted as necessary to prevent inappropriate access.

It is envisioned that the delivery of the correspondence will have several variations of concern that may be classified as “standard”, “confirmation” and “urgent” as selected by the physician or ascertained from lab test results. The standard delivery is performed if the communication reports negative or mildly abnormal results and no important action needs to be taken by the patient. The confirmed delivery is performed when the physician would like to have a confirmation that the patient has received the communication. The medical communication system 210 can optionally provide a separate confirmation that the patient understood the physician's communication. This may be done by a set of the multiple choice questions answered by the patient upon receipt. If the patient answers multiple choice questions “incorrectly”, medical personnel will be automatically notified, and a clinician or a medical secretary will call the patient to discuss the medical condition and assure proper understanding by the patient.

If the medical communication system 210 does not receive the confirmation, it can notify a health care professional. The medical communication system 210 provides a variety of types of such reminders to health care professionals along with proper correspondence. For example, the medical communication system 210 may calendar dates for results on tests, confirmation from patients that correspondence have been received and provide automatic alert notification to a health care professional if the watch for the action item has not been removed before the calendar date arrives.

The above-described confirmations may be executed by, for example, sending reply e-mail by a patient to the system, or dialing a telephone number and confirming receipt of the medical communication by entering one or several selected codes. The urgent delivery mode is executed when urgent as indicated by the physician or when the patient has to take urgent action (for example, to see a physician within the next few hours or next few days). The urgent delivery mode may be performed by a human (e.g., a secretary or nurse may call the patient) or by telephone or email requiring more complete confirmation from the patient or perhaps subsequent verification that the patient arrived at the medical office within a predefined number of hours. Additionally, the medical communication system 210 may be utilized as an intraoffice communication system. For example, a patient's test results may identify a significant issue in health that requires immediate attention. The physician may prepare a medplate to generate a correspondence for a nurse. Based upon the received correspondence, the nurse can make necessary follow up arrangements such as contacting the patient by telephone and scheduling surgery. The choice of delivery method is based on the clinician's judgment, including the latest medical research, most common selections, and risk to the patient.

In another embodiment, the operation of the delivery of the correspondence is automatic upon approval of the medplate 360. This feature may be activated and deactivated as the user wishes. The automatic mode is usually invoked when the test results are within a normal range, or range pre-selected by a physician based on the patient's history and medical examination when ordering the test. The medical communication system 210 may perform a standard delivery for normal or mildly abnormal test results. For example, a physician can order a liver test on a periodic basis for a patient taking accutane or methotrexate, and can specify that if the test results are within normal values the patient will be automatically notified.

There are situations when the automatic mode may be invoked when obtaining abnormal rest results or findings, and the patient needs to have further examination or tests. For example, after performing X-ray mammography, a radiologist may detect a suspicious region on the X-ray image. Frequently, in such a case, the radiologist orders supplemental ultrasound examination of the corresponding breast tissue. The medical communication system 210 would recognize such indication and automatically generate and send an appropriate correspondence.

Similarly, the automatic communication mode can also be invoked if liver test results are highly abnormal, as defined initially by the physician when the test was ordered. In this case the patient will need a suitable explanation, perhaps an order to immediately discontinue the medication, and request to schedule another appointment with the physician as soon as possible. The medical communication system 210 would note the required action by the patient and alert the physician or her staff if the actions were not completed within a specified timeframe. When creating the automatic correspondence, the medical communication system 210 automatically selects the appropriate medical snippet and imports the test result to generate the correspondence for delivery. The correspondence would, of course, indicate that the correspondence was automatically generated. Additionally, the medical communication system 210 can be told to notify the user when the results of the sent laboratory slip are available, or if they have not become available in a proscribed period of time. It is also envisioned that the physician may create new portions of text and store them within a medplate as a snippet for current and future use.

After the medplate 360 is approved, the medical communication system 210 checks the patient demographic database 211 to see if language translation is needed. After performing the language translation, if needed, the medical communication system 210 automatically checks for any required attachments.

Still referring to FIG. 3, the physician may also direct the process to step 318 to allow storing an existing modified medplate as a standard medplate for later retrieval with a different patient. At step 306, the physician may also use the medical communication system 210 to locate a patient and start a process for generating a communication from a medplate even though no test has been initiated. Accordingly, once the information associated with the patient of interest is located, the medical communication system 210 proceeds to step 310 to allow the physician to select a desired medplate based upon review of the patient's information. Once the medplate is modified and approved, the correspondence can be sent as described above.

The medical communication system 210 also serves as an archive for all correspondence as can be seen at step 308. The correspondence that have been generated can be displayed in a list. Each correspondence preferably has an indication as to whether or not the correspondence was sent and if confirmation of delivery was received. Thus, a record of communication is established to serve as an electronic paper trail for evidentiary, research and like purposes. At step 309, the physician may select an archived correspondence for review. Additionally, the medical communication system 210 can present the history of a patient's lab tests and communications for review by the physician. In another embodiment, the medical communication system 210 can link with an expanded electronic medical record to provide further medical history of the patient.

In another embodiment, the medical communication system 210 can also initiate a two-way electronic communication with the patient. The Internet is particularly useful for such an application. According to the Internet embodiment, the snippets are in XML (extensible markup language) and stored in a relational database or repository. Each medical text file is initially written using any word processor and transformed into a software readable-format using the XSLT (extensible style sheet language transformation) technology. The medical communication system 210 can be used to confirm and document follow up conversations with a patient, initiate automatically an office visit, or replace personal communication.

In still another embodiment, the medplate includes a free form text area that is not included in the correspondence generated therefrom. This free form text serves as a location for the physician to legibly record his case notes with test results because the notes are associated with related data and retrievable therewith.

In another embodiment, the physician identifies suitable attachments (such as a prescription, laboratory requisition or other) from a pick list that is a portion of the medplate or an interface with other prescription-writing or test-ordering applications. The physician-may confirm that medical content is current, evidence-based and where possible use the opportunity to provide continuing medical education to the patient. Parts of the snippets may be interfaced with medical, pharmaceutical, biochemical or other sources, databases or references, or other source of information stored on a computer or available over the Internet. In still another embodiment, the medical communication system 210 is used in a veterinarian's office, by executives and, in general, anyone who needs to quickly and efficiently communicate information to assist with such communication

In one embodiment, the medical communication system is a desktop computer application that is either downloaded or provided on a compact disk. In another embodiment, the medical communication system is provided in booklet form for reproduction on a copy machine. In still another embodiment, the medical communication system is offered as an Internet hosted application. Each user is allowed to customize the medplates according to individual preferences. The entity that hosts the medical communication system can monitor the customizations as a means of acquiring feedback on the accuracy and completeness of each medplate. As a result, the original standard medplates can be modified or updated to maintain the medplates in the most desirable form.

It will be appreciated by those of ordinary skill in the pertinent art that the functions of several elements may, in alternative embodiments, be carried out by fewer, or single, element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustration may be incorporated within other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

What is claimed is:

1. A method for providing medical communications to patients comprising the steps of:
receiving first data relating to a test from a laboratory via electronic data interchange;
retrieving second data relating to a patient associated with the first test data;
selecting a medplate based upon the first test data;
autopopulating the medplate based upon the first test data and the second patient data;
applying at least one rule to select default textual fragments based upon the first test data;
providing alternative textual fragments within the medplate;
presenting the medplate for review;
receiving selection input regarding use of the default and alternative textual fragments to modify the medplate;
automatically generating a correspondence based upon the modified medplate; and
providing the correspondence to the patient.

2. A method as recited in claim 1, wherein the at least one rule is an inclusionary rule.

3. A method as recited in claim 1, wherein the at least one rule is an exclusionary rule.

4. A method as recited in claim 1, wherein the default and alternative textual fragments include check boxes, blank fill-in boxes and boxes with pull-down menus.

5. A method as recited in claim 1, further comprising the steps of storing a calendar date for an action based upon the correspondence, and automatically generating a reminder related to the action on the calendar date.

6. A method as recited in claim 1, further comprising the step of requesting confirmation of receipt of the correspondence.

7. A method as recited in claim 6, further comprising the step of archiving the correspondence with a notation as to whether or not the confirmation of receipt was received.

8. A method as recited in claim 6, further comprising the step of, providing an attachment with the correspondence, wherein the attachment is selected from the group consisting of a laboratory requisition, prescription for ordering subsequent clinical tests, a prescription for a medication, a prescription for therapy, a portion of text describing information about subsequent clinical tests, test results, symptoms, health conditions, a prescribed medication, a prescribed therapy, a plurality of recommendations for lifestyle modification, screening, and interactions with health care providers, and a referral to a health care provider.

9. A computer-readable medium whose contents cause a computer system to perform a method for generating physician to patient communication, the computer system having a server program and a client program with functions for invocation by performing the steps of:
receiving first data relating to a test from a laboratory via electronic data interchange;
retrieving second data relating to a patient associated with the first test data;
selecting a medplate based upon the first test data;
autopopulating the medplate based upon the first test data and the second patient data;
applying at least one rule to select default textual fragments based upon the first test data;
providing alternative textual fragments within the medplate;
presenting the medplate for review;
receiving selection input regarding use of the default and alternative textual fragments to modify the medplate;
automatically generating a correspondence based upon the modified medplate; and
providing the correspondence to the patient.

10. A method for generating patient communication from a clinician using a computer for facilitating interaction between a user and a client, comprising:
providing a repository of snippets including patient text and providing a database;
displaying information from said database regarding a selected patient using said display device;
receiving via an interface a selection of at least one snippet from said repository of snippets;
displaying at least a portion of said selected snippet using said display;
enabling interaction with said snippet using said interface to select at least a portion of said snippet; and
generating patient communication based upon the interaction with said snippet.

11. The method of claim 10, wherein said interaction with said snippet includes selecting items from a menu.

12. The method of claim 10, wherein said interaction with said snippet includes selecting or deselecting a text portion.

13. The method of claim 12, wherein said selecting or deselecting includes utilizing a checkbox or drop-down menu.

14. The method of claim 10, wherein said interaction with said snippet includes inserting one or multiple words at a predefined location.

15. The method of claim 10, wherein said interaction with said snippet includes importing data from said database.

16. The method of claim 15, wherein said importing data from said medical database includes displaying one or more of the following: EKG traces, an X-ray image, a CT image and a tangible manifestion of a test result.

17. The method of claim 10, wherein said database is a provider demographic database.

18. The method of claim 10, wherein said database is a hospital information system database.

19. The method of claim 10, wherein said database is a patient demographic database.

20. The method of claim 10 further including generating a laboratory requisition for at least one medical test.

21. The method of claim 20 further including delivering said requisition to a medical facility for performing said at least one medical test.

22. The method of claim 10 further including delivering a prescription to the patient, a pharmacy or other medical facility for filling said prescription based upon the correspondence.

23. The method of claim 10 further including sending said patient communication using one of the following: posting on a Web site, electronic mail, facsimile, postal mail or voice delivery.

24. A method for prescribing medication to a patient by a physician based on received test results, comprising the steps of:
providing a display device and an interface for facilitating interaction between a human and a processor, providing a repository of snippets including patient text, providing a database including patient data;
viewing information regarding a patient including at least one test result using said display device;
selecting at least one snippet from said repository of snippets;
interacting with said snippet using said interface to select at least a portion of said snippet;
generating a patient communication including a prescription for said medication; and
sending said patient communication including said prescription to said patient.

25. The method of claim 24, wherein said generating includes providing a security feature designed to prevent duplication of said prescription.

26. The method of claim 24, wherein said generating includes providing a security feature designed to prevent alteration of said prescription.

27. The method of claim 26, wherein said prescription enables automatic verification of authenticity upon presentation of said prescription.

28. The method of claim 24, wherein said prescription enables, upon dispensation of said medication, automatic notification delivered to a database accessible by said physician.

29. A system for generating patient communication from a physician to a patient using a display device and an interface for facilitating interaction between the physician and a processor, comprising:
first means for generating a medplate including at least one snippet of medical text selected from at least one repository; and
second means for selecting of portions of said medical text for inclusion in said patient communication, wherein said second means is interfaced with at least one database for providing medical information as an attachment to said patient communication.

30. The system of claim 29, further comprising third means for translating said patient correspondence between languages.

31. The system of claim 30, wherein said first, second and third means are computers.

32. The system of claim 29, wherein said first means is also for applying exclusionary rules to said selection when generating said patient communication.

33. The system of claim 29, wherein said exclusionary rules are created to prevent communicating instructions specifying contra-indicated treatment.

34. The system of claim 33, wherein said exclusionary rules are created to prevent prescriptions of medical treatment potentially causing adverse reactions.

35. The system of claim 29, wherein said medical text includes highlighted portions for designating modules of said medical text for improving said intuitive selection.

36. The system of claim 29, wherein the second means is further operative to allow a customization of the medplate and monitoring the customization as feedback.

37. The system of claim 29, wherein the selecting of portions is interactive and intuitive for the physician.

38. The system of claim 29, wherein said patient communication is automatically generated if a normal test result is a basis for generating the medplate.
